(19) United States
(12) Patent Application Publication
(10) Pub. No.: US 2014/0329628 A1
(43) Pub. Date: Nov. 6, 2014

(54) HYDRAULIC CONTROL SYSTEM FOR AUTOMATIC TRANSMISSION

(71) Applicants: Kenta Kimura, Susono-shi (JP); Yuji Hattori, Gotemba-shi (JP); Tomokazu Inagawa, Susono-shi (JP); Takafumi Inagaki, Susono-shi (JP); Yu Nagasato, Susono-shi (JP)

(72) Inventors: Kenta Kimura, Susono-shi (JP); Yuji Hattori, Gotemba-shi (JP); Tomokazu Inagawa, Susono-shi (JP); Takafumi Inagaki, Susono-shi (JP); Yu Nagasato, Susono-shi (JP)

(73) Assignee: TOYOTA JIDOSHA KABUSHIKI KAISHA, Toyota-shi, Aichi (JP)

(21) Appl. No.: 14/360,444

(22) PCT Filed: Dec. 13, 2011
(86) PCT No.: PCT/JP2011/078742

§ 371 Date: May 23, 2014

(51) Int. Cl. F16H 61/02; F16H 61/662

(52) U.S. Cl. CPC F16H 61/0267; F16H 61/662
USPC 474/28

(57) ABSTRACT

A hydraulic control system for an automatic transmission, in which a belt is applied to at least one pair of pulleys, and in which widths of belt grooves of the pulleys, or pressures to clamp the belt by the pulleys are controlled by hydraulic pressures applied to hydraulic chambers of the pulleys. The hydraulic control system is comprised of: a control valve that controls a delivery and a drainage of hydraulic fluid to/from the hydraulic chamber; and a drive frequency setting means that determines a drive frequency of a drive signal for actuating the control valves in such a manner that a phase of a local maximum value of amplitude of the drive signal is shifted from a phase of a local maximum value of amplitude of vibrations resulting from rotating the pulleys.

### TECHNICAL FIELD

The present invention relates to a hydraulic control system for controlling a hydraulic fluid delivered and drained to/from drive and the driven pulleys of a belt-driven continuously variable transmission.

### BACKGROUND ART

A belt-driven continuously variable transmission is comprised of a drive pulley, a driven pulley and a belt driving between those pulleys. In the belt-driven continuously variable transmission, a speed ratio is changed by hydraulically varying a groove width of those pulleys. Meanwhile, a torque transmitting capacity of the belt-driven continuously variable transmission is changed in response to an input torque by hydraulically changing a belt clamping load (i.e., a clamping pressure) of the pulley. The belt-driven continuously variable transmission is mounted on an automobile, and the speed ratio thereof is controlled in such a manner that an engine is operated at a speed possible to minimize fuel consumption rate. The clamping pressure is controlled in such a manner that an engine torque estimated from an opening degree of an accelerator or the input torque of the transmission can be transmitted sufficiently.

The driving belt transmitting a torque between those pulleys is formed by fastening annularly juxtaposing metal pieces called an “element” or a “block” by a hoop or a ring. That is, those metal pieces sequentially enter into and come out of the belt grooves of the pulleys. In addition, a contour of an inner circumference of the belt in the belt groove of the pulley is brought into a polygonal shape. Therefore, a load of the belt applied to the pulley is changed intermittently to vibrate the pulleys and hydraulic chambers thereof. Consequently, a reaction force against the belt clamping load is also vibrated to cause a deformation of the hydraulic chamber and a pulsation of a hydraulic pressure of the hydraulic chamber. Japanese Patent Laid-Open No. 2006-70956 describes a power transmission to provide a communication between the hydraulic chambers of the drive and driven pulleys. In the transmission of Japanese Patent Laid-Open No. 2006-70956, therefore, a resonance of the hydraulic fluid in the hydraulic chambers can be prevented even if the other hydraulic pressure is vibrated. Specifically, the transmission taught by Japanese Patent Laid-Open No. 2006-70956 is comprised of a pair of pulleys and a chain applied to those pulleys. Each pulley is individually comprised of a fixed sheave and a movable sheave allowed to move toward and away from the fixed sheave. To this end, each pulley is individually provided with a hydraulic chamber to which hydraulic fluid is delivered to push movable sheave toward the fixed sheave. According to the teachings of Japanese Patent Laid-Open No. 2006-70956, a spring for pushing the movable sheave toward the fixed sheave is arranged in the hydraulic chamber of each pulley, and constants of the springs are differentiated from each other to suppress the occurrence of resonance.

Japanese Patent Laid-Open No. 2005-291218 describes a control unit of continuously variable transmission configured to avoid an occurrence of resonance in the transmission. According to the teachings of Japanese Patent Laid-Open No. 2005-291218, the control unit is configured to determine an occurrence of resonance by calculating a frequency of vibrations induced by an impact of an entrance of the metal pieces into the belt groove of the pulley, and a resonant frequency of a strait part of the belt between the pulleys. The control unit is then changes a speed ratio in a manner to reduce the resonance.

Japanese Utility Model Laid-Open No. 63-48637 also describes a control system for a continuously variable transmission. The control system taught by Japanese Utility Model Laid-Open No. 63-48637 is configured to carry out a fine adjustment of a speed ratio to suppress a vibration level, for the purpose of reducing vibrations and noises induced by an impact of an entrance of the metal pieces into the belt groove of the pulley.

In turn, Japanese Patent Laid-Open No. 2000-291474 describes a device for solving technical problems related to PWM control of fuel injection pressure. Given that a drive frequency coincides with a natural resonance frequency of the fuel pressure regulating valve during the PWM control of the valve, a pulsation of the pressurized fuel is worsened. According to the teachings of Japanese Patent Laid-Open No. 2000-291474, therefore, the drive frequency is maintained to be higher than a discharge flow rate fluctuation frequency.

The belt driven continuously variable transmission employed in an automobile is required to change a speed ratio quickly in response to a required driving force, a vehicle speed etc., and to change a belt clamping pressure quickly in response to an engine torque or an opening degree of an accelerator. To this end, a delivery and drainage of hydraulic fluid may be controlled by controlling valves by the PWM method. However, a pressure in the hydraulic chamber may be fluctuated by such delivery and drainage of the hydraulic fluid to/from the hydraulic chamber. In addition, a pulsation of the hydraulic fluid in the hydraulic chamber may be induced by a change in a reaction force against a load or hydraulic pressure applied to the hydraulic chamber resulting from rotating the pulleys to transmit the torque. Therefore, in the above-explained transmission taught by Japanese Patent Laid-Open No. 2006-70956, the constant of the spring in the hydraulic chamber of the drive pulley and the constant of the spring in the hydraulic chamber of the driven pulley are differentiated from each other in order not to cause the resonance between the hydraulic fluids in those chambers. However, if the vibration frequency of the hydraulic fluid in any of the hydraulic chamber coincides with the vibration frequency of the hydraulic fluid delivered or drained to/from the hydraulic chamber, the resonance may be caused thereby fluctuating the hydraulic pressure significantly.

As described, the device taught by Japanese Patent Laid-Open No. 2000-291474 reduces vibrations of the belt induced by the resonance by changing the speed ratio. However, the device described therein is not configured to reduce a resonance of the hydraulic fluid governing the clamping pressure, and resultant changes in the speed ratio and the clamping pressure. Likewise, it is also difficult to reduce the change in the speed ratio resulting from the pulsation of the hydraulic fluid by the control system taught by Japanese Utility Model Laid-Open No. 63-48637. In addition, the control system described therein is configured to slightly change the speed ratio. Therefore, an operating speed of the engine may be deviated from a target value thereby deteriorating the fuel economy.

Specifically, the device taught by Japanese Patent Laid-Open No. 2000-291474 is configured to suppress the pulsation of the fuel induced by the vibrations of the delivered and discharged hydraulic fluid. Therefore, if a delivery and a drainage of the hydraulic fluid are carried out at significantly different timings so that pressure fluctuations induced by the delivery of the fluent and induced by the drainage of the fluent have no influence on each other, it is difficult to suppress the pulsation of the hydraulic fluid by the device taught by Japanese Patent Laid-Open No. 2000-291474.

### DISCLOSURE OF THE INVENTION

The present invention has been conceived noting the foregoing technical problems, and it is an object of the present invention is to provide a hydraulic control system for an automatic transmission configured to prevent a changes in a speed ratio and a belt clamping pressure by suppressing a pulsation of hydraulic pressure applied to pulleys.

The hydraulic control system of the present invention is applied to an automatic transmission, in which a belt is applied to at least one pair of pulleys, and in which widths of belt grooves of the pulleys, or pressures to clamp the belt by the pulleys are controlled by hydraulic pressures applied to hydraulic chambers of the pulleys. In order to solve the above-explained problems, the hydraulic control system is comprised of: a control valve that controls a delivery and a drainage of hydraulic fluid to/from the hydraulic chamber; and a drive frequency setting means that determines a drive frequency of a drive signal for actuating the control valves in such a manner that a phase of a local maximum value of amplitude of the drive signal is shifted from a phase of a local maximum value of amplitude of vibrations resulting from rotating the pulleys.

Specifically, the drive frequency setting means determines the drive frequency to be coprime to a frequency of the vibrations resulting from rotating the pulleys.

Optionally, the drive frequency setting means may determine the drive frequency in a manner to be coprime to an integral multiple frequency of the vibrations resulting from rotating the pulleys less than five times the drive frequency.

Alternatively, the drive frequency setting means may determine the drive frequency in a manner to be out of phase to the integral multiple frequency of the vibrations resulting from rotating the pulleys.

The frequency of the vibrations resulting from rotating the pulleys may be obtained by correcting a rotational speed of the pulleys per second.

The hydraulic control system of the present invention is further comprised of a hydraulic sensor for detecting a hydraulic pressure in the hydraulic chamber. Therefore, the frequency of the vibrations resulting from rotating the pulleys may be detected by detecting a frequency of pressure vibrations by the hydraulic sensor.

Specifically, the aforementioned pair of pulleys include a drive pulley and a driven pulley. Accordingly, the drive frequency setting means determines a drive frequency of a drive signal for actuating the control valve communicated with the hydraulic chamber of the drive pulley in a manner such that a phase of the local maximum value of amplitude of the drive signal is shifted from a phase of a local maximum value of amplitude of vibrations resulting from rotating the drive pulley, and a phase of a local maximum value of amplitude of a pressure pulsation in the hydraulic chamber of the driven pulley.

Alternatively, the drive frequency setting means may also determine the drive frequency of the drive signal for actuating the control valve communicated with the hydraulic chamber of the driven pulley in a manner such that a phase of a local maximum value of amplitude of the drive signal is shifted from a phase of the local maximum value of amplitude of vibrations resulting from rotating the driven pulley, and a phase of a local maximum value of amplitude of a pressure pulsation in the hydraulic chamber of the drive pulley.

The hydraulic control system of the present invention is further comprised of: a control device that obtains a control amount of the control valve based on a deviation between an actual hydraulic pressure in the hydraulic chamber and a target hydraulic pressure, and a predetermined control gain, and that outputs the obtained control amount; and a control gain changing means that changes the control gain responsive to a change in the drive frequency in a manner such that a controllability of the control valve will not be changed before and after changing the drive frequency.

Specifically, the control gain changing means is configured to decrease the control gain if the drive frequency is changed to a high-frequency side, and to increase the control gain if the drive frequency is changed to a low-frequency side.

Thus, in the automatic transmission, the widths of belt grooves of the pulleys, and the belt clamping pressure are controlled by controlling the hydraulic fluid delivered to the hydraulic chambers of the pulleys. Those pulleys are rotated by applying a torque to one of those pulleys, and the torque is transmitted to the other pulley by the belt running therebetween. During rotating the pulleys, a reaction force of the belt against the belt clamping pressure of the pulleys is changed intermittently, and as a result, a pulsation of the hydraulic fluid in the hydraulic chamber is induced. Meanwhile, the pressure in the hydraulic chamber is controlled by delivering the hydraulic fluid thereto and draining the hydraulic fluid therefrom. To this end, the drive signal for the control valve is controlled by a PWM method and thereby changed repeatedly. Consequently, a pulsation of the hydraulic fluid delivered and drained to/from the hydraulic chamber is induced. However, the hydraulic control system is configured to determine the drive frequency of the control valve in such a manner that the phase of a local maximum value of amplitude of the drive signal is shifted from the phase of the local maximum value of amplitude of the pressure pulsation resulting from rotating the pulleys. Therefore, the pressure pulsation induced by the drive signal will not enter into resonance with the pressure pulsation resulting from rotating the pulleys. For this reason, changes in the hydraulic pressure in the hydraulic chamber can be suppressed so that a change in the speed ratio and a reduction in the belt clamping pressure are suppressed.

Thus, the pressure pulsation induced by the drive signal is prevented from entering into resonance with the pulsation resulting from rotating the pulleys. For this purpose, a process for determining the frequency of the drive signal (i.e., the drive frequency) may be simplified by merely determining the drive frequency to be coprime to a frequency of the vibrations resulting from rotating the pulleys.

In addition, the above-explained control may be further simplified by obtaining the frequency of the pressure pulsation resulting from rotating the pulleys based on a rotational speed of the pulleys or a detection signal of the hydraulic sensor.

In the automatic transmission to which the present invention is applied, the drive pulley and the drive pulley are rotated by the belt at a speed in accordance with a speed ratio. Therefore, the pressure pulsation in the hydraulic chamber of the drive pulley can be efficiently suppressed by determining the drive frequency of the control valve communicated therewith to be out of phase to the frequency of the pressure pulsation resulting from rotating the drive pulley, and the frequency of the pressure pulsation in the hydraulic chamber of the driven pulley. Alternatively, the pressure pulsation in the hydraulic chamber of the driven pulley can be efficiently suppressed by determining the drive frequency of the control valve communicated therewith to be out of phase to the frequency of the pressure pulsation resulting from rotating the driven pulley, and the frequency of the pressure pulsation in the hydraulic chamber of the drive pulley.

Further, the response and the stability of the feedback control can be prevented from being deteriorated by altering the control gains in accordance with the drive frequency.

### BRIEF DESCRIPTION OF THE DRAWINGS

FIG. 1 is a hydraulic circuit diagram schematically showing one example of a hydraulic circuit of the present invention for controlling a belt-driven continuously variable transmission.

FIG. 2 is a block diagram schematically showing one example of a controller for carrying out a PID control of a hydraulic pressure in a hydraulic chamber.

FIG. 3 is a view explaining a relation between a driving frequency and an electric current.

FIG. 4 is a graph showing a change in I-Q characteristics in accordance with a driving frequency.

FIG. 5 is a table showing one example of a map determining control gains in accordance with a driving frequency.

### BEST MODE FOR CARRYING OUT THE INVENTION

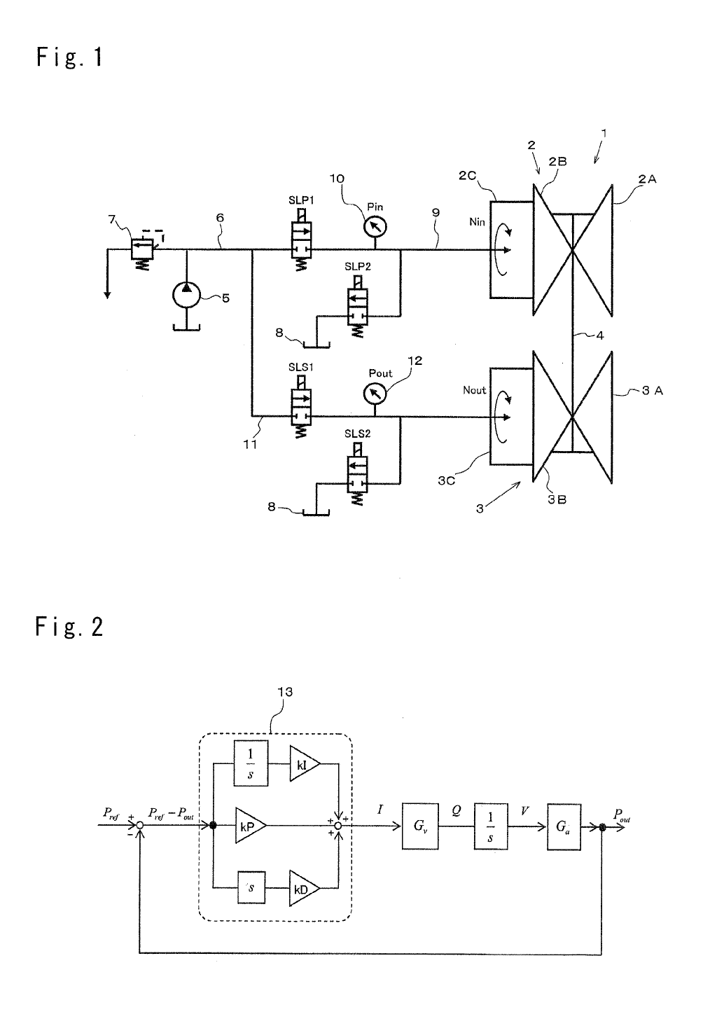

For example, the present invention is applied to an automatic transmission such as a belt-driven continuously variable transmission. Referring now to FIG. 1, there is shown a structure of the belt-driven continuously variable transmission 1. As shown in FIG. 1, the belt-driven continuously variable transmission 1 is comprised of a primary pulley 2 as a drive pulley, a secondary pulley 3 as a driven pulley, and a belt 4 running between those pulleys 2 and 3. Specifically, the primary pulley 2 is comprised of a fixed sheave 2A integrated with a rotary shaft (not shown), and a movable sheave 2B allowed to move closer to and away from the fixed sheave 2A. Sheaves 2A and 2B have inwardly facing conical surfaces to form a belt groove. In addition, the movable sheave 2B is provided with a hydraulic chamber 2C on its back side (i.e., on an opposite side of the conical surface) for hydraulically pushing the movable sheave 2B toward the fixed sheave 2A.

The secondary pulley 3 is structurally similar to the primary pulley 2. Specifically, the secondary pulley 3 is also comprised of a fixed sheave 3A and a movable sheave 3B, and a belt groove formed between inwardly facing conical surfaces. Likewise, the movable sheave 3B is provided with a hydraulic chamber 3C on its back side. Therefore, a width of the belt groove of any one of the pulleys (e.g., the primary pulley 2) is changed by changing an amount of hydraulic fluid or a hydraulic pressure delivered to the hydraulic chamber 2C. Consequently, a running radius of the belt 4 is changed to achieve a desired speed ratio. Meanwhile, the belt 4 is clamped between the fixed sheave 3A and the movable sheave 3B of the secondary pulley 3 by delivering the hydraulic fluid to the hydraulic chamber 3C thereby pushing the movable sheave 2B toward the fixed sheave 2A. That is, a belt clamping pressure is changed in response to the hydraulic pressure applied to the hydraulic chamber 3C of the secondary pulley 3, and a torque transmitting capacity of the transmission 1 is changed in accordance with such change in the belt clamping pressure.

The belt-driven continuously variable transmission 1 is used in an automobile, and hydraulic pressure for controlling the belt-driven continuously variable transmission 1 is established by an oil pump 5 driven by an engine and a motor (both not shown). The hydraulic pressure established by the oil pump 5 is regulated to a line pressure as an initial pressure in the hydraulic control system. In a vehicle, specifically, the line pressure is regulated in accordance with a drive demand such as an opening degree of an accelerator. To this end, a conventional regulating means generally used in the hydraulic control system for an automatic transmission may be employed. Specifically, a pressure regulating valve 7 used in this preferred example is adapted to establish the line pressure in a line pressure passage 6 by regulating a discharge pressure of the oil pump 5 while balancing with a signal pressure outputted based on a drive demand.

In this preferred example, the speed ratio and the belt clamping pressure of the transmission 1 are controlled by delivering hydraulic fluid to the hydraulic chambers 2C and 3C of the pulleys 2 and 3 through the line pressure passage 6, and by draining the fluid to a predetermined drainage site 8 such as an oil pan. To this end, a pressure increasing valve SLP1 is disposed on an oil passage 9 branching off from the line pressure passage 6 to communicate with the hydraulic chamber 2C of the primary pulley 2. Specifically, an electromagnetic valve is used as the pressure increasing valve SLP1, and a drive signal inputted to the pressure increasing valve SLP1 is controlled by a PWM (Pulse Width Modulation) method. The pressure increasing valve SLP1 is opened when energized to deliver the hydraulic fluid to the hydraulic chamber 2C of the primary pulley 2. Preferably, the pressure increasing valve SLP1 is adapted to confine the hydraulic pressure when it is closed completely.

In addition, a pressure reducing valve SLP2 is communicated with the hydraulic chamber 2C of the primary pulley 2. Specifically, the pressure reducing valve SLP2 is adapted to drain the hydraulic fluid to the drainage site 8 when opened. For this purpose, as the pressure increasing valve SLP1, an electromagnetic valve is used as the pressure reducing valve SLP2, and a drive signal inputted to the pressure increasing valve SLP1 is also controlled by the PWM method. In order to detect the hydraulic pressure in the hydraulic chamber 2C of the primary pulley 2 and to send a detection signal, a hydraulic sensor 10 is disposed on the oil passage 9.

Meanwhile, a structure of a hydraulic circuit for controlling the hydraulic pressure applied to the secondary pulley 3 is similar to that of the hydraulic circuit for controlling the hydraulic pressure applied to the primary pulley 2. Specifically, an oil passage 11 branches off from the line pressure passage 6 to communicate with the hydraulic chamber 3C of the secondary pulley 3, and a pressure increasing valve SLS1 is disposed on the oil passage 11. Specifically, an electromagnetic valve is also used as the pressure increasing valve SLS1, and a drive signal inputted thereto is also controlled by the PWM method. Likewise, the pressure increasing valve SLS1 is opened when energized to deliver the hydraulic fluid to the hydraulic chamber 3C of the secondary pulley 3, and preferably adapted to confine the hydraulic pressure when it is closed completely.

Likewise, a pressure reducing valve SLS2 is communicated with the hydraulic chamber 3C of the secondary pulley 3, and the pressure reducing valve SLS2 is adapted to drain the hydraulic fluid to the drainage site 8 when opened. To this end, as the pressure increasing valve SLS1, an electromagnetic valve is used as the pressure reducing valve SLS1, and a drive signal inputted to the pressure increasing valve SLS2 is also controlled by the PWM method. Also, a hydraulic sensor 12 is disposed on the oil passage 11 to detect the hydraulic pressure in the hydraulic chamber 3C of the secondary pulley 3 and to send a detection signal.

Those valves SLP1, SLP2, SLS1 and SLS2 are not adapted to regulate a pressure. Therefore, the hydraulic pressures delivered to the pulleys 2 and 3 are controlled by opening or closing the valves SLP1, SLP2, SLS1 and SLS2 by a feedback control method. To this end, any of conventional feedback control algorism such as a PI control method, a PD control method etc. may be employed. Refereeing now to FIG. 2, there is shown an example of a PID controller 13, and in FIG. 2, “s” represents a Laplace operator. A target pressure Pref is obtained based on a target speed ratio or an opening degree of an accelerator, and a difference between the target pressure Pref thus obtained and an output pressure Pout corresponding to an actual pressure is calculated (Pref−Pout). Accordingly, a proportional action, an integral action and a derivative action are executed based on the difference (i.e., a control deviation) thus calculated. Specifically, a proportional is obtained by processing (i.e., multiplying) the control deviation by a proportional gain kP. Meanwhile, an integral value is obtained by carrying out an integral treatment based on the control deviation, and an integral is obtained by multiplying the calculated integral value by a proportional gain kI. Likewise, a derivative value is obtained by carrying out a derivative treatment based on the control deviation, and a derivative is obtained by multiplying the calculated derivative value by a proportional gain kD.

A sum of those terms is converted into a current value I, and sent to the valves SLP1, SLP2, SLS1 and SLS2. As described, the PWM control is carried out in this preferred example. Accordingly, a pulse signal of certain frequency is individually sent to the valves SLP1, SLP2, SLS1 and SLS2 at a constant voltage so that the current I is applied to each valve SLP1, SLP2, SLS1 and SLS2 according to the frequency of the pulse signal. A relation between the current I and a flow quantity Q (i.e., I-Q characteristics), that is, characteristics of the valves SLP1, SLP2, SLS1 and SLS2 are determined in advance. Therefore, the current I can be converted into the flow quantity Q using a coefficient Gv determined in accordance with the characteristics of the valves. Then, a volume V of the hydraulic fluid delivered or discharged to/from the pulleys 2 and 3 is obtained by integrating the flow quantity Q. Here, the hydraulic fluid used in the belt-driven continuously variable transmission is not completely incompressible, and each hydraulic chamber 2C, 3C is not completely rigid. That is, there is a certain relation between a volume and a pressure of the hydraulic fluid in each hydraulic chamber 2C, 3C depending on a hydraulic rigidity, and such relation is determined in advance as V-P characteristics. Accordingly, a pressure P is obtained based on the volume V using a coefficient Ga representing the V-P characteristics. That is, the pressure thus determined is an output pressure Pout applied to the hydraulic chambers 2C and 3C of the pulleys 2 and 3.

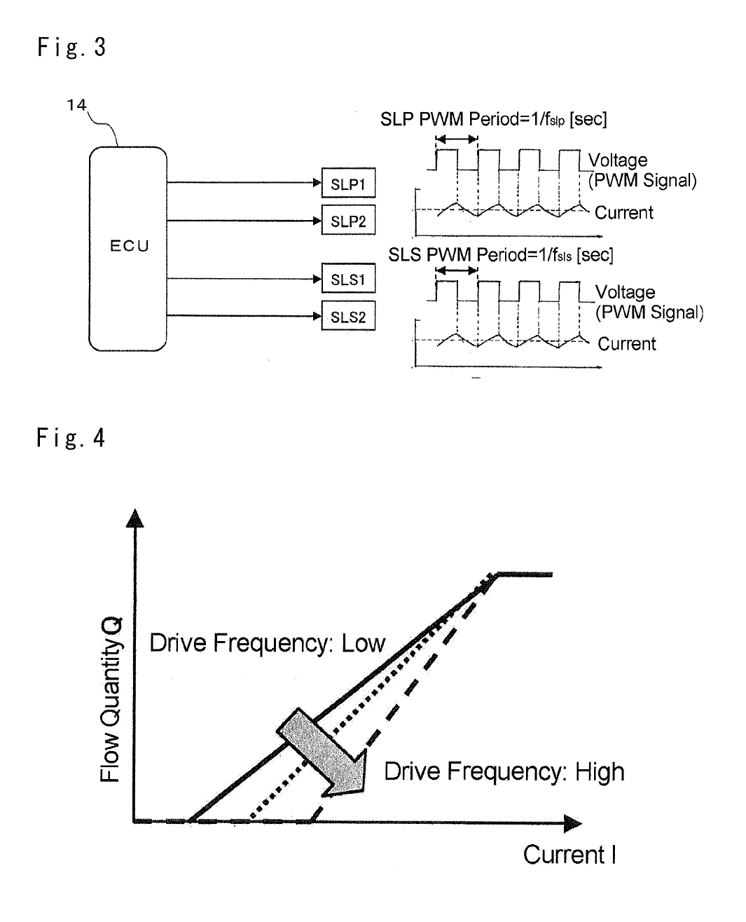

Thus, the pulse signal of certain frequency is sent as a command signal to each valve SLP1, SLP2, SLS1 and SLS2, therefore, the current I is vibrated in response to the frequency of the pulse signal. Referring now to FIG. 3, an electronic control unit (abbreviated as ECU) 14 shown therein is comprised of the aforementioned controller 13, and the ECU 14 sends drive signals to the valves SLP1, SLP2, SLS1 and SLS2 in the form of pulse signals at a constant voltage. Therefore, a current applied to the valve is fluctuated (i.e., oscillated) in response to pulsation of the drive signal, and an amount of the current applied to the valve is increased if the frequency of the drive signal is high. That is, a pressure pulsation (or vibrations) is induced in the hydraulic chamber 2C and 3C depending on the frequency of the pulse signal (i.e., a drive frequency) by delivering or discharging the hydraulic fluid to/from the hydraulic chambers 2C and 3C.

The belt 4 used in the belt-driven continuously variable transmission 1 is formed by annularly juxtaposing a plurality of plate member called an “element” or a “block” in a same orientation, and by fastening the juxtaposing plate members by a hoop or a ring. Therefore, when the pulleys 2 and 3 are rotated, those metal pieces sequentially enter into the belt grooves of the pulleys and come out of the belt grooves of the pulleys. Consequently, a stress acting on each pulley 2, 3 is changed intermittently to cause a pressure pulsation in each hydraulic chamber 2C, 3C.

In order to suppress such pressure pulsation, the hydraulic control system of the present invention is configured to differentiate frequencies of the drive signals for actuating the valves SLP1, SLP2, SLS1 and SLS2 depending on the rotational speeds of the pulleys 2 and 3, or depending on pulse frequencies of the hydraulic fluids in the hydraulic chambers 2C and 3C. Therefore, the pressure pulsation induced by the drive signal will not enter into resonance with the pressure pulsations in the hydraulic chambers 2C and 3C caused mainly by running the belt 4 on the pulleys 2 and 3. To this end, the drive frequency is determined based on the rotational speeds of the pulleys 2 and 3, and frequencies of the pressure pulsations in the hydraulic chambers 2 and 3. For example, the drive frequency is set in such a manner that a phase of an extreme value (i.e., a local maximum value or a local minimum value) of amplitude thereof is shifted from an extreme value of the pressure pulsation caused by rotating the pulleys 2 and 3. Specifically, the drive frequency is determined to be coprime to the frequency of the pressure pulsation caused by rotating the pulley 2 and 3. Here, a definition of the term “coprime” is a relation between two integers having no common divisor other than “1”. For example, such relation between the drive frequency and a rotational frequency of the pulleys 2, 3 can be expressed by the following expression:

fsol≠n·fp (n=1.2,3 . . . )

where fsol is the drive frequency, and fp is the rotational frequency of the pulleys 2, 3.

To this end, the rotational speeds of the pulleys 2, 3 and the hydraulic pressures in the hydraulic chambers 2C, 3C are detected, and the drive frequency fslp can be determined based on the detection results. Then, the detection value of the rotational speed of the primary pulley 2 Nin (rpm) is converted into a rotational speed per second (Nin/60). Specifically, the drive frequency fslp of each of the pressure increasing valve SLP1 and the pressure reducing valve SLP2 is determined as expressed by the following expression:

fslp≠n·fin (n =1.2,3 . . . )

where fin is the frequency of the pressure pulsation resulting from rotating the pulleys 2 and 3 per second. Likewise, in order to determine the drive frequency fsls of each of the pressure increasing valve SLS1 and the pressure reducing valve SLS2, the detection value of the rotational speed of the secondary pulley 3 Nout (rpm) is also converted into a rotational speed per second (Nout/60). Specifically, the drive frequency fsls of each of the pressure increasing valve SLS1 and the pressure reducing valve SLS2 is determined as expressed by the following expression:

fsls≠n·fout (n=1.2,3 . . . )

where fout is the frequency of the pressure pulsation resulting from rotating the pulleys 2 and 3 per second.

The frequency of the pressure pulsation in each hydraulic chambers 2C and 3C resulting from rotating the pulleys 2 and 3 may be changed depending on number of the elements (or blocks), activation of the accelerator, hydraulic pressure, fluid temperature and so on. Therefore, the frequencies of the pressure pulsation fin and fout resulting from rotating the pulleys 2 and 3 may be determined while correcting the rotational speed of those pulleys 2 and 3 per second. For this purpose, a correction coefficient is determined in accordance with number of the elements (or blocks), activation of the accelerator, hydraulic pressure, fluid temperature etc. based on a result of experimentation. Specifically, such correction is realized by retrieving the correction coefficient depending on an actual operating condition of the transmission, and multiplying the rotational speed of the pulleys 2, 3 per second by the correction coefficient. As described, the pressure pulsations in the hydraulic chambers 2C and 3C of the pulleys 2 and 3 can be detected by the hydraulic sensors 10 and 12. Therefore, the frequency of the pressure pulsation can be obtained based on the detection values of those sensors, and the drive frequency can be calculated by substituting the frequency of the pressure pulsation thus obtained by the frequency of the pressure pulsation resulting from rotating the pulleys 2 and 3.

As described, the pressure pulsation is caused in each hydraulic chamber 2C and 3C of the pulley 2 and 3 by controlling the valves SLP1, SLP2, SLS1 and SLS2 for delivering and draining the hydraulic fluid thereto/therefrom by the PWM method. However, the hydraulic control system according to this preferred example adjusts the drive frequencies of the valves in a manner such that the drive frequencies will not enter into resonance with the pressure pulsation in the hydraulic chambers 2C and 3C resulting from rotating the pulleys 2 and 3 (specifically, to the frequency not to cause the resonance within a range of practical use). Therefore, a pulse width of the hydraulic fluid in each hydraulic chamber 2C and 3C will not be widened so that the speed ratio is prevented from being changed and the belt clamping pressure is prevented from being reduced.

In the belt-driven continuously variable transmission 1, the primary pulley and the secondary pulley 3 are connected through the belt 4 to transmit the torque mutually therebetween, and the hydraulic pressure is delivered individually to the hydraulic chambers 2C and 3C from the common line pressure passage. Therefore, a behavior of one of the pulleys 2 and 3 may affect to a behavior of the other pulley. Such mutual effect between the pulleys 2 and 3 may worsen the pulsation of the hydraulic fluid. Specifically, a pressure pulsation in the primary pulley 2 may cause a pressure pulsation in the secondary pulley 3, and a pressure pulsation in the secondary pulley 3 may cause a pressure pulsation in the primary pulley 2. Therefore, it is preferable to determine the drive frequencies of the valves SLP1, SLP2, SLS1 and SLS2 not only taking account of the pressure pulsation in one of the pulley 2 and 3 resulting from rotating those pulleys, but also taking account of the pressure pulsation in the other pulley.

Specifically, the drive frequency fslp of each valve SLP1, SLP2 for the primary pulley 2 is determined to be relatively prime not only to the rotational frequency of the primary pulley 2 but also to a frequency fpout obtained based on the detection value of the hydraulic pressure in the secondary pulley 3. Likewise, the drive frequency fsls of each valve SLS1, SLS2 for the secondary pulley 3 is determined to be relatively prime not only to the rotational frequency fout of the secondary pulley 3 but also to a frequency fpin obtained based on the detection value of the hydraulic pressure in the primary pulley 2.

Consequently, the pressure pulsation governed by the drive frequency of each valve SLP1, SLP2 for the primary pulley 2 will not enter into resonance only with the pressure pulsation induced by a rotation that is contained in the pressure pulsation in the primary pulley 2, but also with the pressure pulsation caused by the pulsation of the hydraulic fluid in the secondary pulley 3. Likewise, the pressure pulsation governed by the drive frequency of each valve SLS1, SLS2 for the secondary pulley 3 will not enter into resonance only with the pressure pulsation induced by a rotation that is contained in the pressure pulsation in the secondary pulley 3, but also with the pressure pulsation caused by the pulsation of the hydraulic fluid in the primary pulley 3.

The frequency of the pressure pulsation in one of the pulleys 2 and 3 which may affect the hydraulic fluid in other pulley may be determined based on the detection value of the hydraulic pressure in said one of the pulleys 2 and 3 detected by the hydraulic sensor 10 or 12. To this end, it is also possible to use a most significant factor in causing a pulsation of the hydraulic fluid. As described, the pressure pulsation in each pulley 2 and 3 is caused by the vibrations of the drive signals for actuating the valves SLP1, SLP2, SLS1 and SLS2, and by the vibrations resulting from rotating the pulleys 2 and 3. However, an effect of the vibrations of the drive signal for the valve to cause a pressure pulsation is different from that of the vibrations resulting from rotating the pulleys. Therefore, the hydraulic fluids in the hydraulic chambers 2C and 3C can be prevented from being fluctuated significantly by determining the drive frequency in a manner not to enter into resonance with the vibratory force having a significant effect to cause the pulsation of the hydraulic fluid.

Specifically, the drive frequency of each valve SPL1 and SPL2 for the primary pulley 2 is determined to be relatively prime to a frequency of a pulsation having a larger vibratory force or a larger effect to cause the pressure pulsation, out of: a frequency of the pressure pulsation resulting from rotating the primary pulley 2; and a frequency of a the pressure pulsation resulting from rotating the secondary pulley 3 and a frequency of the pressure pulsation induced by the drive signals of the valves SLS1 and SLS2. Otherwise, the drive frequency of each valve SPS1 and SPS2 for the secondary pulley 3 is determined to be relatively prime to a frequency of a pulsation having a larger vibratory force or a larger effect to cause the pressure pulsation, out of: a frequency of the pressure pulsation resulting from rotating the secondary pulley 3; and a frequency of a the pressure pulsation resulting from rotating the primary pulley 2, and a frequency of the pressure pulsation induced by the drive signals of the valves SLP1 and SLP2.

In the preferred example, a feedback control is executed to control the valves so as to control the hydraulic pressure delivered to the pulley 2 and 3 of the belt-driven continuously variable transmission. The I-Q characteristics of the valves SLP1, SLP2, SLS1 and SLS2 differ depending on the drive frequency thereof. Especially, the I-Q characteristics of a poppet valve in which a port thereof is closed to confine the hydraulic fluid is changed significantly depending on the drive frequency. An example of the I-Q characteristics is shown in FIG. 4. As can be seen from FIG. 4, the current I increases with an increase in the drive frequency, but the flow quantity Q with respect to the current I of a case in which the current I is large is smaller than that of a case in which the current I is small. In other words, a climb gradient of the flow quantity Q with respect to the current I becomes steeper with an increase in the drive frequency. That is, if the drive frequency is high, a changing amount of the flow quantity Q with respect to a change in the current I is increased. This is similar to a change in a control amount of a case in which a control gain is increased. Therefore, if the drive frequency is increased while maintaining the control gains kP, kI and kD to prior values, a control response will be improved but a control stability will be deteriorated.

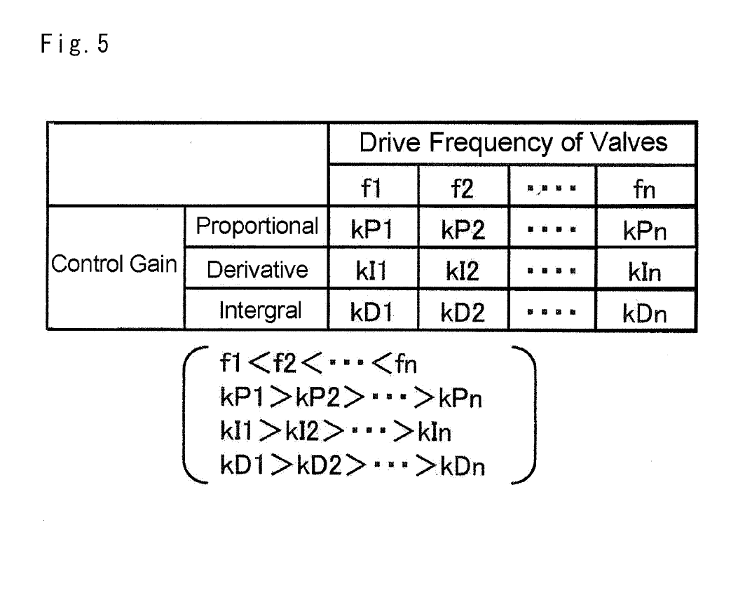

As described, according to the preferred example, the drive frequencies of the valves SLP1, SLP2, SLS1 and SLS2 for controlling the hydraulic pressures delivered to the pulleys 2 and 3 are increased given that the rotational speed of the pulleys 2 and 3 rotated integrally is increased. Therefore, in order to ensure the control stability without deteriorating the control response, the hydraulic control system of the present invention changes the control gain responsive to changes in the drive frequencies of the valves. For example, such control for changing the control gain will be executed during the feedback control shown in FIG. 2. To this end, the control gain kP of the proportional action, the control gain kI of the integral action, and the control kD of the derivative action are individually determined in accordance with the frequencies of the drive signals for the valves SLP1, SLP2, SLS1 and SLS2. Specifically, as can be seen from a map shown in FIG. 5, the control gains kP, kI and kD are individually set to smaller values with an increase in the drive frequency fn. Those values are determined in advance based on results of experimentations and simulations, and preinstalled in the ECU 14 in the form of map. Additionally, those values may be changed continuously in response to a continuous change in the drive frequencies, instead of changing stepwise as shown in FIG. 5.

Thus, according to the preferred example, the control gains kP, kI and kD are changed in accordance with the frequencies of the drive signals for the valves. Specifically, if the drive frequency is increased, the control gains kP, kI and kD are decreased. In contrast, if the drive frequency is decreased, the control gains kP, kI and kD are increased. Therefore, changes in the control response and the control stability are compensated by thus changing the the control gains kP, kI and kD. Consequently, the control response and the control stability of the hydraulic control system can be maintained without being changed significantly.

As described, the drive frequency is determined to be coprime to the frequency of the pressure pulsation resulting from rotating the pulleys. To this end, specifically, the drive frequency may be set to be coprime to an integral multiple frequency of the pressure pulsation resulting from rotating the pulleys less than five times the drive frequency. As also described, those frequencies are set to relatively prime to each other for the purpose of shifting a phase of a local maximum value of the pressure pulsation governed by the drive frequency from a phase of a local maximum value of the pressure pulsation resulting from rotating the pulleys or a phase of a local maximum value of the pressure pulsation caused by the other pulley. For this purpose, the drive frequency may also be determined by other methods in a manner such that the phases of the local maximum values of the pressure pulsations are to be out of phase, instead of setting the drive frequency of the valve to be coprime to the frequencies of the pressure pulsations caused by the other factors.

The foregoing determination of the drive frequencies of the valves are carried out by the electronic control unit 14. Accordingly, the electronic control unit 14 having such functions serves as the drive frequency setting means of the present invention.

1. A hydraulic control system for an automatic transmission, in which a belt is applied to at least one pair of pulleys, and in which widths of belt grooves of the pulleys, or pressures to clamp the belt by the pulleys are controlled by hydraulic pressures applied to hydraulic chambers of the pulleys, comprising:
a control valve that controls a delivery and a drainage of hydraulic fluid to/from the hydraulic chamber; and
a drive frequency setting means that determines a drive frequency of a drive signal for actuating the control valves in such a manner that a phase of a local maximum value of amplitude of the drive signal is shifted from a phase of a local maximum value of amplitude of a pressure pulsation in the hydraulic chamber resulting from rotating the pulleys.

2. The hydraulic control system for an automatic transmission as claimed in claim 1,
wherein the drive frequency setting means includes a means that determines the drive frequency to be coprime to a frequency of the pressure pulsation in the hydraulic chamber resulting from rotating the pulleys.

3. The hydraulic control system for an automatic transmission as claimed in claim 1,
wherein the drive frequency setting means includes a means that determines the drive frequency in a manner to be coprime to an integral multiple frequency of the pressure pulsation in the hydraulic chamber resulting from rotating the pulleys less than five times the drive frequency.

4. The hydraulic control system for an automatic transmission as claimed in claim 1,
wherein the drive frequency setting means includes a means that determines the drive frequency in a manner to be out of phase to the integral multiple frequency of the pressure pulsation in the hydraulic chamber resulting from rotating the pulleys.

5. The hydraulic control system for an automatic transmission as claimed in claim 1,
wherein the frequency of the pressure pulsation in the hydraulic chamber resulting from rotating the pulleys includes a frequency obtained by correcting a rotational speed of the pulleys per second.

6. The hydraulic control system for an automatic transmission as claimed in claim 1, further comprising:
a hydraulic sensor that detects a hydraulic pressure in the hydraulic chamber; and
wherein the frequency of the pressure pulsation in the hydraulic chamber resulting from rotating the pulleys includes a frequency of hydraulic vibrations detected by the hydraulic sensor.

7. The hydraulic control system for an automatic transmission as claimed in claim 1,
wherein the pair of pulleys include a drive pulley and a driven pulley; and
wherein the drive frequency setting means includes a means that determines a drive frequency of a drive signal for actuating the control valve communicated with the hydraulic chamber of the drive pulley in a manner such that a phase of the local maximum value of amplitude of the drive signal is shifted from a phase of a local maximum value of amplitude of a pressure pulsation in the hydraulic chamber resulting from rotating the drive pulley, and a phase of a local maximum value of amplitude of a pressure pulsation in the hydraulic chamber of the driven pulley.

8. The hydraulic control system for an automatic transmission as claimed in of claim 7,
wherein the drive frequency setting means includes a means that determines the drive frequency of the drive signal for actuating the control valve communicated with the hydraulic chamber of the driven pulley in a manner such that a phase of a local maximum value of amplitude of the drive signal is shifted from a phase of the local maximum value of amplitude of a pressure pulsation in the hydraulic chamber resulting from rotating the driven pulley, and a phase of a local maximum value of amplitude of a pressure pulsation in the hydraulic chamber of the drive pulley.

9. The hydraulic control system for an automatic transmission as claimed in claim 1, further comprising:
a controller that obtains a control amount of the control valve based on a deviation between an actual hydraulic pressure in the hydraulic chamber and a target hydraulic pressure, and a predetermined control gain, and that outputs the obtained control amount; and
a control gain changing means that changes the control gain responsive to a change in the drive frequency in a manner such that a controllability of the control valve will not be changed before and after changing the drive frequency.

10. The hydraulic control system for an automatic transmission as claimed in claim 9, wherein the control gain changing means is configured to decrease the control gain if the drive frequency is changed to a high-frequency side, and to increase the control gain if the drive frequency is changed to a low-frequency side.
